(19) United States
(12) Patent Application Publication
(10) Pub. No.: US 2013/0266917 A1
(43) Pub. Date: Oct. 10, 2013

(54) METHOD AND KIT FOR PROVIDING A TRAINING COURSE FOR OPERATING A TOWING DEVICE

(71) Applicant: CAA SOUTH CENTRAL ONTARIO, Thornhill (CA)

(72) Inventors: Henry Freriks, Kitchener (CA); Karen Moore, Scarborough (CA)

(73) Assignee: CAA South Central Ontario, Thornhill (CA)

(21) Appl. No.: 13/850,684

(22) Filed: Mar. 26, 2013

Related U.S. Application Data
(60) Provisional application No. 61/622,196, filed on Apr. 10, 2012.

(51) Int. Cl. G09B 19/00

(52) U.S. Cl. CPC G09B 19/00
USPC 434/219

(57) ABSTRACT

Method and kit for providing a training course for operating a towing device.

### FIELD

The described embodiments relate to providing a training course to tow truck operators and, in particular, relate to a method and kit for providing a training course for operating a towing device.

### BACKGROUND

Tow truck operators typically require training in order to learn how to operate a tow truck, about the operation of a tow truck, and how a towing device may be used with additional components in order to tow, extricate and bring rolled over objects, such as vehicles, to an upright position across towing surfaces, such as roads. There exists a need for improved methods and kits for providing a training course to tow truck operators, or at least an alternative.

### SUMMARY

In a first aspect, some embodiments described herein provide a line tension simulation board kit for providing a training course to tow operators comprising: at least one load; an activity board comprising a plurality of towing surfaces; at least one tow simulator comprising a line and a tow mechanism for towing extricating or pulling into an upright position the load using the line, wherein in operation the tow simulator is affixed to the activity board in a position to tow, extricate or pull to an upright position the load on at least one of the towing surfaces; and a measuring device for measuring a tension of the line when the tow simulator is towing the load.

In accordance with some embodiments, at least some of the towing surfaces are texturized. In accordance with some embodiments, the texturized towing surfaces are selected from the group consisting of: road, grass, ice, water, sand, mud, and gravel.

In accordance with some embodiments, the towing surfaces may be grade adjustable. In accordance with some embodiments, the towing surfaces are grade adjustable by connecting the towing surfaces to a main towing surface of the activity board using a pivot or hinge mechanism.

In accordance with some embodiments, the line tension simulation board kit may further comprise a snatch block for use in towing at least one load using at least one tow simulator; wherein the snatch block is operable to reduce the tension of the load on the line.

In accordance with some embodiments, the tow simulator may comprise at least one winch simulator and at least one boom simulator. In accordance with some embodiments, the tow simulator may comprise a fishing reel.

In accordance with some embodiments, the tow simulator may comprise a clamp for affixing the tow simulator to the activity board.

In accordance with some embodiments, the activity board may further comprise an anchor point for changing a towing direction of the load.

In another aspect, embodiments described herein may provide a method of providing a training course to tow truck operators using a line tension simulation board kit comprising: providing at least one load; providing an activity board comprising a plurality of towing surfaces; affixing at least one tow simulator to the activity board, wherein said tow simulator may comprise a line and a tow mechanism for towing the load using the line, wherein the tow simulator is affixed to the activity board at a position to tow extricating or pulling into an upright position the load on at least one of the towing surfaces; and conducting one or more training exercises using at least one load, the activity board and at least one tow simulator, wherein conducting the one or more training exercises may comprise: towing extricating or pulling into an upright position the at least one load across at least one of the towing surfaces using the at least one tow simulator; measuring a tension of the load on the line using a measuring device when the tow simulator is towing the load.

In accordance with some embodiments, conducting one or more training exercises may comprise: using a snatch block to tow extricate or pull to an upright position the at least one load using at least one tow simulator, wherein the snatch block is operable to reduce the tension of the load on the line; measuring another tension of the load on the line using a measuring device when the snatch block is used for towing the load.

In accordance with some embodiments, at least some of the towing surfaces may be grade adjustable, and wherein conducting one or more training exercises may comprise: adjusting a towing surface that is grade adjustable to a first grade; towing extricating or pulling into an upright position the at least one load across the towing surface at the first grade using the at least one tow simulator; measuring a first tension of the load on the line using a measuring device when the tow simulator is towing the load across the towing surface at the first grade; adjusting the towing surface that is grade adjustable to a second grade; towing the at least one load across the towing surface at the second grade using the at least one tow simulator; measuring a second tension of the load on the line using a measuring device when the tow simulator is towing the load across the towing surface at the second grade.

In accordance with some embodiments, at least some of the towing surfaces are texturized, and wherein conducting one or more training exercises may comprise: towing extricating or pulling into an upright position the at least one load on a first texturized towing surface at the first grade using the at least one winch simulator; measuring a first tension of the load on the line using a measuring device when the tow simulator is towing the load across the first texturized towing surface; towing extricating or pulling into an upright position the at least one load on a second texturized towing surface using at least one tow simulator; and measuring a second tension of the load on the line using a measuring device when the tow simulator is towing the load across the second texturized towing surface.

### BRIEF DESCRIPTION OF THE DRAWINGS

A preferred embodiment of the present invention will now be described in detail with reference to the drawings, in which:

FIG. 1 illustrates an activity board of a line tension simulation board kit for providing a training course to tow truck operators in accordance with embodiments described herein;

FIG. 2 illustrates a load, a tow simulator, and a measuring device of a line tension simulation board kit for providing a training course to tow truck operators in accordance with embodiments described herein; and

FIG. 3 illustrates a method of providing a training course to tow truck operators using a line tension simulation board kit.

### DESCRIPTION OF EXEMPLARY EMBODIMENTS

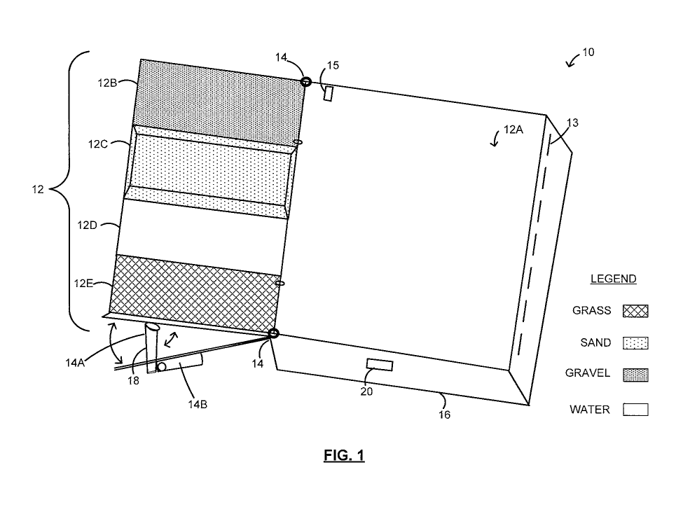

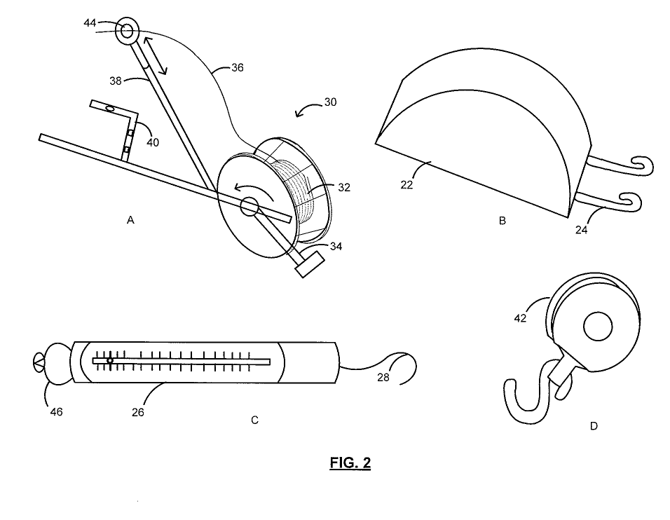

Reference is first made to FIGS. 1 and 2, which illustrate a line tension simulation board kit for providing a training course to tow truck operators in accordance with embodiments described herein.

FIG. 1 illustrates an activity board 10 of a line tension simulation board kit for providing a training course to tow truck operators in accordance with embodiments described herein. The activity board 10 may have one or more towing surfaces 12 representing surfaces that a tow truck may tow an object over.

In accordance with embodiments described herein, the activity board 10 may have at least some towing surfaces 12 that are texturized. The texturized towing services 12 may represent or simulate a variety of surfaces that a tow truck may tow an object over such as a road, grass, ice, water, sand, mud, and gravel. As shown in the example illustration of FIG. 1, the activity board 10 may be partitioned into a main towing surface 12A and multiple texturized towing surfaces 12B, 12C, 12D, 12E. As an example, a texturized towing surface 12B may be implemented using sandpaper to represent a gravel towing surface. Another example, a texturized towing surface 12C may be implemented using a removable box that is filled with sand, water or mud to represent a sand surface, water surface and or a mud surface, respectively. A further example, a texturized towing surface 12D may be implemented using a removable lid that contains ice or may be implemented using a similarly slippery surface, such as plastic or glass to represent or simulate an ice surface. Another example, a texturized towing surface 12E may be implemented using artificial turf or grass to represent or simulate a grass surface. Other textured towing surfaces 12 may also be used. One or more of the towing surfaces 12 may also be flexible or pliable in order to simulate bumps, hills, ditches and so on.

In accordance with embodiments described herein, the activity board 10 may have at least one towing surface 12 that is grade adjustable. For example, at least one towing surface 12 may be grade adjustable by pivotally, hingedly, rotationally or otherwise connecting the towing surfaces to a main towing surface 12A of the activity board 10 such that the towing surface 12 can adjust with respect to a main towing surface 12A to different grades, slopes, levels, positions, heights, and so on. That is, one or more towing surfaces 12 may move with respect to a main towing surface 12A.

In accordance with embodiments described herein, the towing surface 12 may be held in various positions via a support 18. For example, the support 18 may be connected to the towing surfaces 12 via a hinge 14 or other mechanism so that the support 18 may move between a supporting position and a rest position. In the supporting position, the support 18 may extend vertically or perpendicular to the towing surfaces 12 in order to support the towing surfaces 12 and hold in a desired position. In a supporting position, the towing surfaces 12 may be elevated to the same plane as the main towing surface 12A or inclined above the main towing surface 12 such that the towing surface 12 slopes down to the main towing surface 12A.

When a towing surface 12 is inclined above the main towing surface 12 this may simulate a downhill or downward sloping surface. The length of the support 18 may vary depending on a desired position, slope or grade of the towing surface 12 relative to the main towing surface 12A. Further, the support 18 may be inclined or angled with respect to the towing surfaces 12 to move to a lower height then if fully perpendicular to the towing surfaces 12. In the rest position, the support 18 may extend parallel to the towing surfaces 12 so that the towing surfaces 12 may extend below the main towing surface 12A such that the towing surfaces 12 slope up towards to the main towing surface 12A. When a towing surface 12 is below the main towing surface 12 this may simulate a ditch, uphill or upward sloping surface.

The towing surfaces 12B, 12C, 12D, 12E may be independently grade adjustable, or a subset of the towing surfaces 12B, 12C, 12D, 12E may be coupled or connected together (or form part of single surface with different textures thereon) so that the set of towing surfaces 12 are grade adjustable together. If the towing surfaces 12 are independently grade adjustable then each may have its own support 18 of the same height or different heights.

Reference is now made to FIG. 2, which illustrates a load 22, a tow simulator 30, and a measuring device 26 of a line tension simulation board kit for providing a training course to tow truck operators in accordance with embodiments described herein.

A line tension simulation board kit for providing a training course to tow truck operators may further comprise at least one load 22 representing or simulating the object (such as vehicle) to be towed, extricated or placed in the upright position in the case of a rolled over vehicle, and at least one tow simulator 30 comprising a line 36 and a tow mechanism for towing the load 22 using the line 36. In operation, the tow simulator 30 is affixed to the activity board 10 in a position to tow the load 22 across at least one of the towing surfaces 12 using the line 36. The line tension simulation board kit for providing a training course to tow truck operators may further comprise a measuring device 26 for measuring a tension on the line 36 when the tow simulator 30 is towing, extricating or placing the load in an upright position if the load has rolled over 22.

The tow simulator 30 may comprise at least one winch simulator 32 (or freewheel or winch engagement) and at least one boom simulator 38. For example, the tow simulator 30 may have one winch simulator 32, two winch simulators 32, or other number of winch simulators 32.

The winch simulator 32 represents or simulates a winch of a tow truck. A winch is a device that is used to pull in (wind up) or let out (wind out) or otherwise adjust the tension of a line used to tow an object. A winch may include a spool (or winch drum or reel) and, in some cases, a mechanism for winding the line 36 around the spool such as an attached crank or handle. More elaborate winch simulator 32 designs may have gear assemblies and may be mechanical or can be powered by electric, hydraulic, pneumatic or internal combustion drives, for example. Some may include a brake or ratchet (such as solenoid or mechanical) and pawl device to prevent it from unwinding unless the pawl is retracted. The line 36 may be stored on the winch simulator 32 (as shown in FIG. 2) or may be otherwise engaged with the winch simulator so that it may otherwise pull in or let out the line 36. The winch simulator 32 may be implemented using components configured to pull in, let out, or otherwise adjust the tension of the line 36. In an illustrative example embodiment, the tow simulator 30 may include a winch simulator 32 that is implemented using components of a fishing reel connected to a boom-like component sized proportionally to the fishing reel. The tow simulator 30 may further comprise a handle 34 engaged with the winch simulator 32 and configured to turn the spool so that the line 36 winds around the spool, and conversely unwinds around the spool. The boom simulator 38 may be manual, motorized, or automated.

The boom simulator 38 represents or simulates a boom of a tow truck. The boom simulator 38 may be configured to be height adjustable and may comprise a pulley 44 and eye or sheave at an end to thread the line 36 through.

The tow simulator 30 may further comprise a clamp mechanism 40 for affixing the tow simulator 30 to the activity board 10 into slots 13 on the side for provision of the training exercises. For example, the clamp mechanism may be a bracket, a D ring or a simulated D ring that may be secured to slots 13 in the activity board 10. Other mechanisms may also be used to affix the tow simulator 30 to the activity board 10.

In addition to the components illustrated in the figures, the tow simulator 30 may include other components such as a hook and chain, wheel lift, and bed (not shown) for use during a training exercise.

The line tension simulation board kit may further comprise a measurement device 26 for measuring the tension of the load 22 on the line 36. The measurement device 26 may be implemented using a scale with a hook mechanism 28 and an attachment mechanism 46 so that the measurement device 26 may be connected to both the load 22 and the line 36, or other components of the line tension simulation board kit. The measurement device 26 may be configured to indicate a maximum tension of the load 22 on the line 36 while the load 22 is towed, extricated or brought to an upright position if rolled over, across a towing surface 12, as the tension may fluctuate while the load 22 is towed, extricated or brought to an upright position if rolled over, across the towing surface 12.

In accordance with some embodiments described herein, the line tension simulation board kit further comprises a snatch block 42 for reducing the tension on the line 36 when the tow simulator 30 is towing the load 22 across one or more of the towing surfaces 12. That is, the snatch block 42 is operable to reduce tension of the load 22 on the line 36. In operation, the snatch block 42 is connected to the load 22 and the line 36 is thread through the snatch block 42. The line 36 is then connected to the measuring device 26 which is in turn connected to the boom simulator 38 or other component of the tow simulator 30, in order to tow the load 22 across a towing surface 10 using the line 36.

The line tension simulation board kit may further comprise an anchor point 15 to simulate towing at different angles and directions. The anchor point 15 may be movable to different positions on the activity board 10 relative to the tow simulator 30 and load 22 in order to change the direction and angle of tow.

The training course provided to tow truck operators may include different training exercises involving different components of the line tension simulation board kit. For example, a training exercise may illustrate how the snatch block 42 reduces the tension of the load 22 on the line 36. For example, a training exercise may involve a comparison between the tension of the load 22 on the line 36 when the towing simulator 30 is used to tow, extricate or turn the load 22 upright across a towing surface 12 when the snatch block 42 is not used, and the tension of the load 22 on the line 36 when the towing simulator 30 is used to tow, extricate or turn upright the load 22 across a towing surface 12 when a snatch block 42 is used.

As another example, different texturized towing surfaces 12 may be used in a training exercise for tow truck operators in accordance with embodiments described herein. For example, the training course may involve using the activity board 10 to demonstrate how different texturized towing surfaces 12 affect the tension of the load on the line 36 when an object is towed, extricated or turned upright over the surface using a tow simulator 30 (FIG. 2). The training course may demonstrate pulling the load 22 on different surface types simulated by different texturized towing surfaces 12. The training course may use a level towing surface 12 or different grades of towing surfaces 12 on different texturized towing surfaces 12. Further, the training course may use a snatch block 42 on a level towing surface 12 or different grades of towing surfaces 12 on different texturized towing surfaces 12. Finally, the training course may demonstrate directional pulls or towing at an angle. The training course may involve measuring the tension of a load 22 on the line 36 when the tow simulator 30 tows, extricates or turns upright the load 22 over texturized towing surfaces 12 for subsequent comparison to other measured tensions that correspond to different texturized towing surfaces 12.

As a further example, the grade adjustable towing surfaces 12 may be used in a training exercise provided for tow truck operators in accordance with embodiments described herein. For example, the training course may involve using the activity board 10 to demonstrate how the different grades of towing surfaces 12 affect the tension of the load on the line 36 when an object is towed over the surface at the different grades using a tow simulator 30. The training course may involve measuring the tension of a load 22 on the line 36 when the tow simulator 30 tows, extricates or turns upright the load 22 over a towing surface 12 positioned at one grade for subsequent comparison to other measured tensions that correspond to towing surfaces 12 at different grades. The training course may also use a snatch block 42 on different grades of towing surfaces 12. As another example, a training exercise may simulate angle effects on a snatch block 42 and directional pulls. As a further example, a training exercise may show the use of a snatch block 42 to re-direct pulls.

Multiple activity boards 10 may be used to show various combinations of training exercises. For example, a combination of training exercises may be used to demonstrate how pulling a load 22 on different types of towing surfaces 12 (such as texturized towing surfaces 12) and different slopes of towing surfaces 12 may affect the tension on the line 36. The training exercises may also demonstrate how a snatch block 42 may change the tension on the line 36.

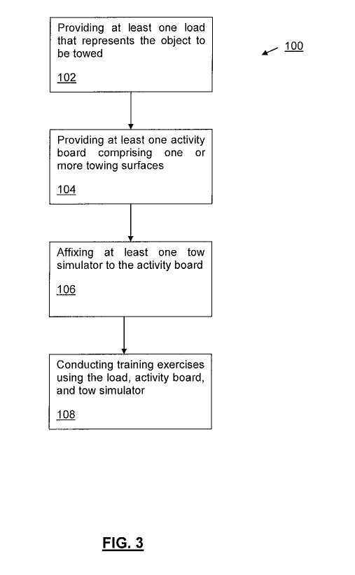

Reference is now made to FIG. 3, which illustrates a method 100 of providing a training course to tow truck operators using a line tension simulation board kit.

At step 102, the method 100 involves providing at least one load 22 that represents an object to be towed, extricated or, if rolled over, turned to an upright position. The load 22 may have a connecting mechanism 24 (such as a hook, for example) so that the load 22 may be connected to a measurement device 26, towing mechanism 30 (including line 36), snatch block 42, and the like. The load 22 may be a metal weight with hooks 24 for connecting to the tow simulator 30. In accordance with some embodiments, the weight of the load 22 will be proportional to the weight of the object that the load 22 represents. For example, the load 22 may represent a vehicle and the weight of the load 22 may be proportional to the weight of a vehicle. In other embodiments, the weight of the load 22 may be arbitrary and not proportional to the weight of an object to be towed, extricated or turned upright.

At step 104, the method 100 involves providing an activity board 10, where the activity board 10 comprises one or more towing surfaces 12. As explained herein, the towing surfaces 12 may be texturized to represent various surfaces that a tow truck may tow an object over. For example, the towing surfaces 12 may be texturized to represent grass, ice, water, sand, mud, gravel, and so on, using artificial turf, actual grass, acrylic, glass, plastic, sand, mud, gravel, rocks, sandpaper and other materials.

At step 106, the method 100 involves affixing at least one tow simulator 30 to the activity board 10. The tow simulator comprises a line 36, a tow mechanism (such as winch simulator 32 and a boom simulator 36) for towing the load 22 using the line 36, and an attachment mechanism 38 (such as the clamp) for affixing the tow simulator 30 to the activity board 10. The tow simulator 30 is affixed to the activity board 10 at a position to tow, extricate or pull the load to an upright position 22 across at least one of the towing surfaces 12. In an example embodiment, the tow mechanism may be a freewheel or winch engagement 32. Other tow mechanisms may also be used.

At step 108, the method 100 involves conducting one or more training exercises using at least one load 22, the activity board 10 and at least one tow simulator 30. Conducting one or more training exercises involves towing, extricating or pulling into an upright position at least one load 22 across at least one of the towing surfaces 12 using at least one tow simulator 30, and may further involve measuring a tension of the load 22 on the line 36 using a measuring device 26 when the tow simulator 30 is towing the load 22.

In accordance with embodiments described herein, conducting one or more training exercises involves illustrating how a snatch block 42 reduces the tension in the line 36 when the tow simulator 30 is used to tow a load 22 across one or more of the towing surface 12. For example, the method 100 may involve threading the line 36 through a snatch block 42 block that is operable to reduce the tension of the load 22 on the line 36 and connecting the snatch block 42 to the load 22 using the hooks 24, for example. The line 36 may then be attached to a D ring or bracket on the tow simulator 30 and the measurement device 26, making sure that the line 36 is not crossed or tangled. When the tow simulator 30 tows the load 22 across one or more towing surfaces 12, the method 100 involves measuring the tension of the load 22 on the line 36 using a measuring device 26 when the snatch block is used for towing, extricating or pulling the load to an upright position. The training exercise involves a comparison between the tension of the load 22 on the line 36 when the snatch block 42 is not used, and the tension of the load 22 on the line 36 when a snatch block 42 is used, in order to illustrate how the snatch block 42 reduces the tension of the load 22 on the line 36. A comparison may also be made using the snatch block 42 with different types of towing surfaces 12 and different slopes of towing surfaces 12.

In accordance with embodiments described herein, at least some of the towing surfaces 12 are grade adjustable, and the training exercises involve illustrating how adjusting towing surfaces 12 to different grades affects the tension of the load 22 on the line 36 when the load 22 is towed across the towing surfaces 12 using the towing simulator 30. The training exercise may involve adjusting a towing surface 12 that is grade adjustable to a first grade. The training exercise further involves towing at least one load 22 across the towing surface 12 at the first grade using at least one tow simulator 30, and measuring a first tension of the load 22 on the line 36 using a measuring device 26 when the tow simulator 30 is towing the load 22 across the towing surface 12 at the first grade 14A.

The training exercise may then involve adjusting the towing surface 12 that is grade adjustable to a second grade 14B. Alternatively or additionally, a different towing surface 12 that is adjusted to a different grade than the first grade may be used instead of adjusting the towing service 12 at the first grade to another grade. The training exercise then further involves towing at least one load 22 across the towing surface 12 at the second grade using at least one tow simulator 30, and measuring a second tension of the load 22 on the line using a measuring device 26 when the tow simulator 30 is towing the load 22 across the towing surface 12 at the second grade. The training exercise may then involve comparing the first measured tension to the second measured tension to see how the different grades affect the tension of the load 22 on the line 36. This may be repeated for multiple grades. The same towing surface 12 may be used and adjusted to different grades, or different towing surfaces 12 positioned at different grades may be used. At least one tow simulator 30 may be affixed to the activity board 10 at a position to tow the load 22 across at least one of the towing surfaces 12. The towing surface 12 may be positioned to the desired grade. For example, the support 18 may be used to hold the towing surface 12 at the desired grade or slope. For example, the support 18 may be positioned perpendicular to the towing surface 12 to position the towing surface at a first grade 14A. The support 18 may collapse and run along the towing surface 12 to move the towing surface 12 to a second grade 14B, which may slope downward at approximately a 45 degree angle from the main towing surface 12A in this example. This is an example only and more than two grades may be used and the towing surface 12 may be adjusted to different angles relative to the main towing surface 12A. Additionally, each towing surface 12B, 12C, 12D, 12E may be independently adjustable, each with its own support 18 for example. For example, a block or additional support may be used to extend the length of the support 18 to move the towing surface 12 at a different angle relative to the main towing surface 12A. At least one load 22 that represents an object to be towed is placed on the activity board aligned with the towing surface 12 positioned to the desired grade or slope. The load 22 may have a connecting mechanism 24 so that the load 22 may be connected to a measurement device 26. The line 36 of the towing simulator 30 may then be connected to the measurement device 26. The measurement device 26 may then be set to zero at the start of the training exercise. The training exercise may involve pulling the load 22 over one of the towing surfaces 12 positioned at the desired slope. As the tow simulator 30 pulls the load 22 over the sloped towing surface 12 the weight measurement from the measurement device 26 is determined and recorded. This may be repeated for the different slopes or grades of the towing surface 12 as well as for different texturized towing surfaces 12 positioned at different grades. Combinations of different textures and slopes may be used for the training exercise.

In accordance with embodiments described herein, the towing surfaces may be texturized and different texturized towing surfaces 12 may be used in a training exercise for tow truck operators. For example, the training course may involve using the activity board 10 to demonstrate how different texturized towing surfaces 12 affect the tension of the load on the line 36 when an object is towed over the surface using a tow simulator 30. The training course may involve measuring the tension of a load 22 on the line 36 when the tow simulator 30 tows the load over a texturized towing surfaces 12 for subsequent comparison to other measured tensions that correspond to different texturized towing surfaces 12. At least one tow simulator 30 may be affixed to the activity board 10 at a position to tow the load 22 across at least one of the towing surfaces 12. For example, the activity board 10 may have different brackets in different positions corresponding to each of the texturized towing surfaces 12. Each bracket may be aligned with the corresponding texturized towing surface 12 in order to affix the tow simulator 30 to the activity board 10 in a position aligned with the corresponding texturized towing surface 12. A tow simulator 30 is then positioned within the desired bracket. At least one load 22 that represents an object to be towed is placed on the activity board 10. The load 22 may have a connecting mechanism 24 (such as a hook, for example) so that the load 22 may be connected to a measurement device 26. The line 36 of the towing simulator 30 may then be connected to the measurement device 26. The measurement device 26 may then be set to zero at the start of the training exercise. The towing surfaces 12 of the activity board 10 may be texturized to represent various surfaces that a tow truck may tow an object over. For example, the towing surfaces 12 may be texturized to represent grass, ice, water, sand, mud, gravel, and so on, using artificial turf, actual grass, ice, water, sand, mud, gravel, rocks, sandpaper and other materials. The first portion of a training exercise may involve pulling the load 22 over one of the types of texturized towing surfaces 12. As the tow simulator 30 pulls the load 22 over one type of texturized towing surface 12 the weight measurement from the measurement device 26 is determined and recorded. This may be repeated for the additional types of texturized towing surfaces 12 and the tow simulator 30 may be moved to the different slots corresponding to the different texturized towing surfaces 12. Alternatively, different texturized towing surfaces 12 may be movable to a position in alignment with the slot. The texturized towing surfaces 12 themselves may be fixated to the activity board 10, and they may be adjusted or moved. Just as the tow simulator 30 can fits into various notches to align with texturized towing surfaces 12, the various texturized towing surfaces 12 be moved or adjusted into different positions and locations to align with the tow simulator 30 and other components. In accordance with embodiments described herein, conducting one or more training exercises may involve illustrating how a snatch block 42 reduces the tension in the line 36 when the tow simulator 30 is used to tow a load 22 for various combinations of different types of towing surface 12 and different slopes of towing surfaces 12.

In accordance with other embodiments described herein, conducting one or more training exercises may involve simulating angle effects or demonstrating directional pulls using a snatch block 42. For example, an obstacle, such as a tree, may be in the way of a direct line between the object to be towed and the tow truck. The object may need to be pulled in one direction and then in another direction in order to tow the object around the obstacle. The activity board 10 and training exercise may be used to simulate such a directional pull. The activity board 10 may include an anchor point 15 positioned at a desired angle or direction relative to the load 22. The anchor point 15 may be used to anchor or fix the snatch block 42 or other device at a desired position on the activity board 10. The anchor point 15 may be movable to different locations on the activity board 10 depending on the desired direction or angle, and position of the load 22. For example, for a 90 degree pull the anchor point 15 may be positioned in line with the load and off to one side to create an L shape configuration with the tow simulator 30, the anchor point 15 and the load 22. Other examples include a 60 degree pull and a parallel pull. A snatch block 42 may be attached to the anchor point 15. The line 36 may be thread through the snatch block 42 and then connected to the measurement device 26. The load 22 may have a connecting mechanism 24 so that the load 22 may be connected to a measurement device 26. The tow simulator 30 may then be used to tow the load 22 in a direction relative to the position of the anchor point 15 to simulate a directional pull. Further, training exercises may involve re-direct pulls to determine where to position the anchor point 15 and the snatch block 42 relative to the load 22 in order to move the load 22 around an obstacle such as a tree. The snatch block 42 and anchor point 15 may be moved to various positions to demonstrate different directional pulls and how various placements change the direction and angle of the pull.

Embodiments have been described here by way of example only. Various modification and variations may be made to these exemplary embodiments, which are limited only by the appended claims.

We claim:

1. A line tension simulation board kit for providing a training course to tow operators comprising:
at least one load;
an activity board comprising a plurality of towing surfaces;
at least one tow simulator comprising a line and a tow mechanism for towing extricating or pulling into an upright position the load using the line, wherein in operation the tow simulator is affixed to the activity board in a position to tow, extricate or pull to an upright position the load on at least one of the towing surfaces; and
a measuring device for measuring a tension of the line when the tow simulator is towing the load.

2. The line tension simulation board kit of claim 1 wherein at least some of the towing surfaces are texturized.

3. The line tension simulation board kit of claim 2 wherein the texturized towing surfaces are selected from the group consisting of: road, grass, ice, water, sand, mud, and gravel.

4. The line tension simulation board kit of claim 1 wherein all of the towing surfaces are grade adjustable.

5. The line tension simulation board kit of claim 4 wherein the towing surfaces are grade adjustable by connecting the towing surfaces to a main towing surface of the activity board using a pivot or hinge mechanism.

6. The line tension simulation board kit of claim 1 further comprising a snatch block for use in towing at least one load using at least one tow simulator; wherein the snatch block is operable to reduce the tension of the load on the line.

7. The line tension simulation board kit of claim 1 wherein the tow simulator comprises at least one winch simulator and at least one boom simulator.

8. The line tension simulation board kit of claim 1 wherein the tow simulator comprises a fishing reel.

9. The line tension simulation board kit of claim 1 wherein the tow simulator comprises a clamp for affixing the tow simulator to the activity board.

10. The line tension simulation board kit of claim 6 wherein the activity board further comprises an anchor point for changing a towing direction of the load.

11. A method of providing a training course to tow truck operators using a line tension simulation board kit comprising:
providing at least one load;
providing an activity board comprising a plurality of towing surfaces;
affixing at least one tow simulator to the activity board, wherein said tow simulator comprises a line and a tow mechanism for towing the load using the line, wherein the tow simulator is affixed to the activity board at a position to tow extricating or pulling into an upright position the load on at least one of the towing surfaces; and
conducting one or more training exercises using at least one load, the activity board and at least one tow simulator, wherein conducting the one or more training exercises comprises:
towing extricating or pulling into an upright position the at least one load across at least one of the towing surfaces using the at least one tow simulator;
measuring a tension of the load on the line using a measuring device when the tow simulator is towing the load.

12. The method of claim 11 wherein conducting one or more training exercises comprises:
using a snatch block to tow extricate or pull to an upright position the at least one load using at least one tow simulator, wherein the snatch block is operable to reduce the tension of the load on the line;
measuring another tension of the load on the line using a measuring device when the snatch block is used for towing the load.

13. The method of claim 11 wherein at least some of the towing surfaces are grade adjustable, and wherein conducting one or more training exercises comprises:
adjusting a towing surface that is grade adjustable to a first grade;
towing extricating or pulling into an upright position the at least one load across the towing surface at the first grade using the at least one tow simulator;
measuring a first tension of the load on the line using a measuring device when the tow simulator is towing the load across the towing surface at the first grade;
adjusting the towing surface that is grade adjustable to a second grade;
towing the at least one load across the towing surface at the second grade using the at least one tow simulator;
measuring a second tension of the load on the line using a measuring device when the tow simulator is towing the load across the towing surface at the second grade.

14. The method of claim 11 wherein at least some of the towing surfaces are texturized, and wherein conducting one or more training exercises comprises:
towing extricating or pulling into an upright position the at least one load on a first texturized towing surface at the first grade using the at least one winch simulator;
measuring a first tension of the load on the line using a measuring device when the tow simulator is towing the load across the first texturized towing surface;
towing extricating or pulling into an upright position the at least one load on a second texturized towing surface using at least one tow simulator; and
measuring a second tension of the load on the line using a measuring device when the tow simulator is towing the load across the second texturized towing surface.
